(19) United States
(12) Patent Application Publication
(10) Pub. No.: US 2018/0272564 A1
(43) Pub. Date: Sep. 27, 2018

(54) Flex-Cure Pneumatically Applied Wet Blanket

(71) Applicant: Flex-Cure LLC, Jordan, MN (US)

(72) Inventors: Tom Sloan, St. Cloud, MN (US); Ryan Haglund, Coon Rapids, MN (US); Morgan J. Lloyd, Jordan, MN (US)

(73) Assignee: Flex-Cure LLC, Jordan, MN (US)

(21) Appl. No.: 15/895,696

(22) Filed: Feb. 13, 2018

Related U.S. Application Data
(60) Provisional application No. 62/476,208, filed on Mar. 24, 2017.

(51) Int. Cl. B28C 5/12; C04B 30/02; C04B 40/02; C04B 41/53

(52) U.S. Cl. CPC B28C 5/1261; C04B 30/02; C04B 2111/00163; C04B 41/5307; C04B 40/0295

(57) ABSTRACT

A method of curing concrete beginning with the acquisition of seedless hydro mulch material and incorporating the material into a material spraying device, mixing the material with water in the spraying device and spraying the material and water onto the surface of curing concrete. The spraying device includes a spray nozzle and pressurized air is introduced into the spray nozzle prior to the spraying of the material and water onto the curing concrete. The pressurized air may be provided to the spray nozzle at an air pressure of equal to or greater than 35 psi and less than or equal to 75 psi.

### CROSS-REFERENCE TO RELATED APPLICATIONS

This application claims priority to Provisional Patent Application Ser. No. 62/476208 filed Mar. 24, 2017, the entire contents of which is incorporated by reference herein in its entirety.

### STATEMENT REGARDING FEDERALLY SPONSORED RESEARCH OR DEVELOPMENT

Not Applicable.

### BACKGROUND

Hydro mulch is currently used in hydro seeding applications such as along roads, lawns, and the like. Hydro mulch technology currently sprays hydro mulch over a relatively level ground surface and leaves a lumpy, oatmeal-like product. Hydro mulch applications seek to comprehensively cover all exposed ground surfaces. Unfortunately, the pumps used in the application of hydro mulch frequently fail to provide satisfactory coverage of a uniform thickness over a desired surface. Frequently, another application of hydro mulch product is required, over bare spots, in order to ensure better coverage.

The invention is generally used to facilitate concrete repair which currently employs the use of either shotcrete or hand applied concrete, which in turn is conveyed through a hose, and is pneumatically projected onto a surface. Currently, after the concrete is applied, the concrete is covered with burlap or polyester to retain moisture during a 3-7 day period of time required for curing the concrete. Retention of moisture is difficult and is expensive during curing of the concrete since the holding of a burlap/polyester product adjacent to vertical or overhead surfaces represents construction challenges.

In general, small cracks form in concrete used on bridges due to imperfections in the curing process, or during exposure to moisture, temperature, or other weather conditions.

In the past, traditional concrete curing components may include toxic materials which may be harmful to individuals or the environment. In addition, construction employees are frequently unable to add water or moisture following the pouring of the concrete to attempt to regulate the temperature during the curing process.

In the past, in warm and hot temperatures, it has been very difficult to control the moisture content of curing concrete, leading to evaporation of water and cracking during the curing process. In addition, it is frequently difficult to pour concrete and cure concrete previously poured onto a sloped, vertical, or overhead surface. The current invention in some embodiments is sprayed onto sloped, vertical, and/or overhead surfaces.

In the past, Styrofoam shell-cut ribs incorporating rebar have been used in poured concrete resulting in structural cracks inside of the concrete and cracks on the outside of the concrete, due to non-optimal curing process and curing process conditions.

In the past, spraying of hydro mulch on a roadside did not include the introduction of air to facilitate the spraying process. Hydro mulch seed trucks did not use compressed air during the application process because of the perceived waste of energy. The absence of a compressed air application process has resulted in non-uniform application of mulch, causing splotches or splats of hydro mulch material to be applied onto a designated surface.

In the past, pouring of concrete on overhead surfaces or vertical services has frequently resulted in moisture retention of 30% or less.

In the past, in order to attempt to regulate the curing of concrete, construction employees have been required to apply cold water onto the curing concrete which in many instances may result in temperature shock, because the applied water is more than 20° cooler than the temperature of the curing concrete. The temperature shock, due to the application of cold water onto curing concrete surfaces, facilitates cracking of the poured concrete during the curing process.

In the past, construction techniques have attempted to slow down of the change in temperature of poured concrete in order to keep the concrete moist during curing, which reduces cracking. In addition, attempts have been made to avoid large changes in temperature during curing and drying of the concrete at an excessively rapid rate.

The art referred to and/or described herein is not intended to constitute an admission that any patent, publication or other information referred to is “prior art” with respect to this invention. In addition, this section should not be construed to mean that a search has been made or that no other pertinent information as defined in 37 C.F.R. § 1.56(a) exists.

All U.S. patents and applications and all other published documents mentioned anywhere in this application are incorporated herein by reference in their entireties.

Without limiting the scope of the invention, a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided for the purposes of complying with 37 C.F.R. § 1.72.

### BRIEF SUMMARY OF THE INVENTION

In at least one embodiment the invention relates to a method of curing concrete where a seedless hydro mulch is obtained and the seedless hydro mulch is placed into a spraying device, the seedless hydro mulch is mixed with water in the spraying device and the mixed seedless hydro mulch is sprayed onto a designated surface of poured or applied concrete to facilitate curing.

The invention also may also utilize a modified spray nozzle during the spraying of the mixed seedless hydro mulch and water onto the poured or applied concrete during the curing process.

The invention may further introduce compressed air into the modified spray nozzle immediately prior to the spraying of the mixed seedless hydro mulch and water onto poured or applied concrete to facilitate curing.

In at least one embodiment the invention relates to a concrete curing system including a hydro mulch device, the hydro mulch device having a tank where hydro mulch and water are deposited in the tank, a pump, a conduit, a spray nozzle in communication with the conduit, the spray nozzle having a valve and a spray tip.

The invention further includes a source of compressed air, the source of compressed air having a second conduit, the second conduit being in communication with the spray nozzle proximate to the tip.

In at least one embodiment the invention relates to a method of covering a surface where a seeded or seedless hydro mulch is obtained and is incorporated into a hydro mulch spraying device, the hydro mulch is mixed with water in the spraying device and the mixed hydro mulch and water is sprayed onto the surface.

The invention further uses a modified spray nozzle during the spraying of the mixed hydro mulch and water.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE DRAWINGS

A detailed description of the invention is hereafter described with specific reference being made to the drawings in which:

FIG. 1 is an environmental view showing the practice of one embodiment of the method of the invention.

FIG. 2 is an alternative environmental view showing the practice of one alternative embodiment of the method of the invention.

FIG. 3 is an alternative environmental view showing the practice of one alternative embodiment of the method of the invention.

FIG. 4 is an alternative detail environmental view showing a vertical surface which has received the application of hydro mulch according to the method of one embodiment of the invention.

FIG. 5 is an detail environmental view of one alternative embodiment of a spray nozzle used in the practice of one embodiment of the method of the invention.

FIG. 6 is an isometric environmental view of one alternative embodiment of a spray nozzle used in the practice of one embodiment of the method of the invention.

FIG. 7 is a block diagram of the practice of the method of the invention.

### DETAILED DESCRIPTION OF THE INVENTION

In general, one embodiment of the invention is directed to a solution to integrity and durability problems inherent with all methods currently employed in the construction industry to properly cure concrete 12 which is poured or applied in a variety of difficult field conditions. Immediately after concrete 12 is placed onto a surface and finished, the critical chemical process of hydration begins. In order for the hydration process to yield concrete of specific design strength, proper curing is a significant factor to be considered within engineering calculations. However, proper curing of the concrete 12 is seldom achieved in field applications. Proper concrete 12 curing is vital to quality, durability, ultimate strength, water-tightness and is especially essential in colder climate conditions, to provide resistance to freeze-thaw concrete degradation.

During the first 3-7 days of the hydration (hardening) process for curing concrete 12, it is essential to achieve proper design strength, where individuals attempt to regulate factors such as moisture and temperature levels for the concrete 12, in order to maintain the curing concrete 12 within a very narrow band-width optimal range of curing parameters.

Concrete hydration issues, which are especially difficult to control, occur during the repair of concrete structures, i.e., bridges, parking ramps, walls, dams, marine structures and the like. Concrete repair projects often present accessibility challenges which may be exacerbated by the use of high cement, low water/cement ratio concrete 12, thin cross-sections of the concrete matrix, and even the need for small aggregate, all of which contribute to shortcomings existing with the implementation of the current concrete cure control methodologies.

Attempts by contractors, owners representatives and/or engineers to provide proper maintenance to vertical surfaces 14 and the underside of decks 16, where moisture and temperature conditions are variable, and where thin sections of repair concrete 12 have been previously applied, are especially difficult providing inconsistent results at best. Also, proper curing of the thin (2″) cover of very rich concrete overlays to repaired bridge decks 18 is extremely difficult for very different reasons.

The standard industry practice for curing concrete 12 applied to vertical surfaces 14, the underside of decks 16, and overhang structural repairs, is to affix wet burlap, polyester, chemical products or a combination of wet burlap, polyester and chemical products to the surface of the concrete 12 to be cured. Similarly, on thin concrete 12 overlay bridge decks 18, combinations of the use of wet burlap, polyester and chemical products are attempted in order to obtain desired concrete curing conditions.

Maintaining a desired moisture level for an extended period of time on curing concrete 12 applied to vertical surfaces 14 is an obvious challenge. In addition, to maintaining a horizontal deck surface 18 with a desired moisture content, the challenge of the management of temperatures of the hydrating concrete 12 has proven unsatisfactory.

During the curing process for curing concrete 12 applied to bridge decks 18, burlap and polyester are used to completely cover the surface, and moisture may be applied to the burlap and polyester to assist in regulation of the temperature and moisture of the curing concrete 12. In addition, the burlap and polyester may retain moisture initially, but along with the moisture, exothermic heat of hydration is trapped in the covered deck sections, and in the inevitable wind-swept sections of the covered deck yield dried deck and concrete conditions.

Alternatively, the known burlap or polyester covering materials may be immersed in cold water which may then be disposed over an overheating, recently placed, cement rich concrete 12 overlay. ACI and PCA standards strongly advise that the water temperatures used during the immersion techniques for covering materials be no more than 20 degrees cooler than the temperature of the curing concrete 12 in order to mitigate cracking. In the real world, curing concrete 12 may be exposed to thermal shock when volumes of water used in the material immersion technique are more than 20 degrees cooler than the hydrating concrete 12.

The method of invention described herein may be generally referred to by the numeral 10. The method 10 in general, applies and adheres a flexible wet blanket 20 formed of hydro mulch material 22 to previously applied concrete 12 surfaces, which are hydrating/curing. In some embodiments the wet blanket 20 may be applied through a spray device and be composed of a mixture of wood fibers, emulsion and water.

The spray application of the wet blanket 20 onto curing concrete 12 provides complete coverage of a desired surface. In some embodiments the wet blanket 20 may be formed of mulch, and may be permeable or non-permeable, and receptive to re-administration of moisture, if necessary, through exposure to a warmed or un-warmed spray or other water application. Re-watering of the wet blanket 20 may occur through an elected type of spray pattern as emitted from a common watering spray nozzle attached to a conduit such as a hose, or through another type of water application device, or through exposure to ambient temperature water mist.

It should also be noted that the re-moistening of the wet blanket 20, applied upon curing concrete 12, reduces the risk of exposing the curing concrete 12 to thermal shock. In some embodiments the re-moisturization of the wet blanket 20 may occur by the addition of water which may be more or less than 20 degrees removed from the temperature of the curing concrete 12.

In some embodiments the use of the wet blanket 20 formed of mulch enables construction personnel to easily visualize and determine the moisture condition of the wet blanket 20, so that an undesirable level of drying may be easily remedied by re-moisturization.

In some embodiments the wet blanket 20 is breathable where the materials forming the blanket allow for excess heat to be dissipated through the blanket. In addition, the material forming the wet blanket 20 does not require the application of voluminous amounts of cold water for re-wetting, therefore, temperature shock will not be a factor contributing to premature concrete 12 cracking. In some alternative embodiments, the wet blanket 20 may not be breathable.

In some embodiments, the mulch material selected to form the wet blanket 20 may be thoroughly vetted for its environmental impact. In some embodiments, the hydro mulch material 22 forming the wet blanket 20 may be hydro seeding material routinely spread along roadways, aggregate stockpiles and river banks; without or with the grass seed.

In some embodiments directed to shotcrete projects and bridge deck overlay wet blanket applications, an area of coverage of 300 square feet is provided. In alternative embodiments the area of coverage may be more than 300 square feet or less than 300 square feet at the discretion of an individual and dependent upon the ambient project conditions.

The implementation of the inventive method 10 in some embodiments will utilize two individuals: a 300 gallon Bowie Hydro Mulcher Device, or other machine/equipment which is equally capable of mixing and pumping hydro mulch product 22 onto applied concrete 12 to cover the same with the wet blanket 20. In some embodiments more or less than two individuals will practice the inventive method 10. In some embodiments a tank 40 for the hydro mulch device 42 may be larger or smaller than 300 gallons dependent upon the size of the area to be covered by the wet blanket 20, or to accommodate varying ambient project conditions.

In some embodiments the inventive method 10 will utilize approximately 75 to 125 gallons of water within the tank 40 of the hydro mulch device 42, the exact amount of water is subject to specific application and condition requirements. In some embodiments one 50 lb bale of Flextera®, or similar or like product, or other Department of Transportation approved hydro mulch material 22 will be added to the water within the tank 40 of the hydro mulch device 42. In at least one embodiment the motor for the agitator or mixer 44 for the hydro mulch device 42, following the introduction of the water and mulch material will be agitated for approximately 5-7 minutes. The duration of agitation of the water and mulch may vary, and be longer than 7 minutes and shorter in time than 5 minutes dependent on the specific application and condition requirements.

The inventive method in some embodiments includes the introduction of compressed air into a modified spray nozzle 26 to facilitate the provision of 100% coverage to a selected concrete 12 surface or area, while simultaneously enhancing the control of the thickness of the applied wet blanket material in response to varying ambient conditions.

In some embodiments, a spray application hose 24 transporting hydro mulch material 22 may be integral to or releasably secured to the hydro mulch device 42. A unique spray nozzle 26 may be attached to the application end of the hose 24 or turret spray gun for the hydro mulch device 42. In at least one embodiment, an airline 28 may be attached to the spray nozzle 26 for receipt of pressurized air from an air source such as an air compressor 38.

During the application of the wet blanket 20 the pressurized air introduced to the spray nozzle 26 may be regulated by a valve 30 to provide a pressurized air flow of approximately 35 psi to 75 psi. The application step of the method 10 initiates upon the spraying of a mixture of the Flex Cure Pneumatic Wet Blanket in a sweeping, layering application to a thickness of approximately 3/16″ thickness. The thickness of the wet blanket 20 may vary depending on site conditions, and the thickness of the wet blanket 20 may be larger than 3/16″ or thinner than 3/16″ dependent on the specific application and condition requirements. Following the completion of the application of the wet blanket 20, the hydro mulch device 42 and spraying equipment may be cleaned through the addition of approximately 50-75 gallons of water for agitation within the tank 40 for approximately 3 minutes, whereupon the mixed cleaning water may be sprayed out of the spray nozzle 26 to remove any excess material.

In some embodiments directed to shotcrete projects and bridge deck overlay wet blanket applications, an area of coverage of 6000 square feet is provided. In alternative embodiments the area of coverage may be more than 6000 square feet or less than 6000 square feet at the discretion of an individual and dependent upon the ambient project conditions. The implementation of the inventive method 10 in some embodiments will utilize two individuals: an 1100 gallon Bowie Hydro Mulcher Device 42, or other machine/equipment which is equally capable of mixing and pumping hydro mulch product 22 onto applied concrete 12 to cover the same with the wet blanket 20.

In some embodiments more or less than two individuals will practice the inventive method 10. In some embodiments a tank 40 for the hydro mulch device 42 may be larger or smaller than 1100 gallons dependent upon the size of the area to be covered by the wet blanket 20 or to accommodate varying ambient project conditions.

In some embodiments the inventive method 10 will utilize approximately 1050 gallons of water within the tank 40 of the hydro mulch device 42, where the exact amount of water is subject to specific application and condition requirements. In some embodiments ten to eleven fifty pound bales of Flextera®, or similar or like product, or other Department of Transportation approved hydro mulch material 22 will be added to the water within the tank 40 of the hydro mulch device 42. In at least one embodiment the motor for the agitator/mixer 44 for the hydro mulch device 42, following the introduction of the water and mulch material will be agitated for approximately 5-7 minutes. The duration of agitation of the water and mulch may vary, and be longer than 7 minutes and shorter in time than 5 minutes dependent on the specific application and condition requirements.

In some embodiments, a spray application hose 24 may be integral to or releasably secured to the hydro mulch device 42. A unique spray nozzle 26 may be attached to the application end of the hose 24 or turret spray gun for the hydro mulch device 42. In at least one embodiment, an airline 28 may also be attached to the spray nozzle 26 for receipt of pressurized air from a pressurized air source such as an air compressor 38. During the application of the wet blanket 20 the pressurized air introduced to the spray nozzle 26 may be regulated by a valve 30 to provide a desired pressurized air flow of between approximately 35 psi and 75 psi. The application step of the method 10 initiates upon the spraying of a mixture of the Flex Cure Pneumatic Wet Blanket onto a bridge deck 18 in a sweeping, layering application to a thickness of approximately ⅛″ to 5/16″ in thickness. The thickness of the wet blanket 20 may vary depending on site conditions which may be larger than 5/16″ or thinner than ⅛″ dependent on the specific application and condition requirements.

Following the completion of the application of the wet blanket 20 the hydro mulch device 42 and spraying equipment may be cleaned through the addition of approximately 200 gallons of water for agitation within the tank 40 for approximately 3-5 minutes, whereupon the mixed cleaning water may be sprayed out of the spray nozzle 26 and onto the bridge deck 18 in a light mist in order to simultaneously moisturize the wet blanket 20 and to remove any excess material from the tank 40.

In at least one alternative embodiment a fill tank may be used for the supply of water for misting during the hydration of the wet blanket 20. In some embodiments the method may include the use of a heating device to warm the water disposed in the fill tank of the hydro mulch device 42 to reduce the likelihood of temperature shock during the practice of the method.

In at least one alternative embodiment, the use of compressed air may be omitted from the practice of the inventive method. In alternative embodiments the use of compressed air and spray nozzle 26 allow for precise placement of the mulch product upon a curing concrete 12 surface.

In at least one embodiment, the method of the invention replaces the use of burlap/polyester as known in the prior art by substituting the use of hydro mulch as sprayed onto the curing concrete 12, where the wet hydro mulch material 22 may receive additional moisture at a future time, to regulate the curing parameters to reduce concrete cracking.

In at least one embodiment the invention is directed to a method of employing hydro mulch type technology to coat uncured concrete, especially on vertical surfaces, with a hydro mulch product 22 that will reduce the undesirable risk of dehydration of the concrete 12 during a normal 3-7 day curing period of time. The hydro mulch material 22 of the invention may be rewetted after a period of hours or days as needed, to ensure the curing concrete 12 does not dehydrate at an undesirable rate given the specific application and condition requirements.

In order to provide improved coverage of hydro mulch material 22 upon a curing concrete 12 surface the volume of the pressurized air may be adjusted by an air compressor controller 50 to provide accurate control over the thickness of the hydro mulch coverage upon the uncured concrete 12.

In at least one embodiment, the spray nozzle 26 includes a valve 30. Valve 30 is in communication with the air compressor 38 and air line 28.

In some embodiments the spray nozzle 26 may be formed of aluminum, or other light weight material to provide the spray nozzle 26 with a convenient weight. In alternative embodiments the spray nozzle 26 may be formed of alternative materials including other metals, PVC, other plastics, carbon materials or combinations thereof.

In at least one embodiment the entry port 32 for material entering the spray nozzle 26 may include an orifice having a diameter dimension of approximately 1½″. In alternative embodiments the diameter dimension for the orifice for the entry port 32 may be larger than 1½″ or smaller than ½″ dependent upon specific application and condition requirements.

In at least one embodiment the exit port 34 of the spray nozzle 26 may include an orifice having a diameter dimension of approximately ½″ to ¾″. In alternative embodiments the diameter dimension for the orifice for the exit port 34 may be larger than ¾″ or smaller than ½″ dependent upon specific application and condition requirements.

The disclosed product and method may be used in bridge rehabilitation and repair. The disclosed invention allows construction employees to more closely regulate temperature and curing of poured or applied concrete 12, which in turn reduces cracking prolonging the useful life of the concrete 12 used as construction materials within a bridge, dam, parking ramp, for example. The objects/surfaces receiving concrete 12 described herein have been provided for purposes of illustration only and are not intended to be limiting, and other surfaces may receive concrete and the application of the method described herein.

In one embodiment of the invention, a valve 30 is used to regulate air in order to aerate a hydro mulch product 22, to regulate temperature, moisture, and curing time for the poured or applied concrete 12.

In some embodiments, the hydro mulch product 22 may be provided in bales or in bulk of approximately fifty pounds of material, and mixed with approximately 100 gallons of water per unit of material prior to spray application upon poured or applied concrete 12.

The method and process described herein in some embodiments may be used in rebuilding of dams, tunnels, bridges, or other locations which include a vertical or overhead surface to facilitate curing of concrete 12.

In some embodiments the spray depth or thickness of the hydro mulch product 22 disposed over curing concrete 12 may be varied to facilitate a desired level of water retention during the curing process.

In some embodiments, the hydro mulch material 22 does not include seeds. The hydro mulch 22 product is allowed to remain on the concrete 12 for a period of time of approximately seven days, then the concrete 12 may also cure for an additional 21 day period of time.

In some embodiments the curing of the concrete 12 is complete when the sprayed wet hydro mulch blanket 20 is dried, whereupon the hydro mulch blanket 20 may be swept or blown off of the cured concrete 12 surface.

In some embodiments compressed air is introduced proximate to the spray nozzle 26 to facilitate the reduction/break-up of the hydro mulch material 22 during the air spreading onto poured or applied concrete 12.

In some embodiments the spray control may include an adjustable valve 30 integral to a valve fitting, where the valve 30 is used to increase or reduce the volume of pressurized air discharged from the spray nozzle 26. Regulation of the volume of pressurized air at the spray nozzle 26 also alters the velocity of hydro mulch material 22 exiting the spray nozzle 26, and the application of the hydro mulch material 22 onto a concrete 12 surface. In some embodiments the PSI to be introduced to the spray nozzle 26 is initially established or set, and regulated by an air compressor controller 50.

In some embodiments, pressurized air introduced into the hydro mulch material 22 also regulates the temperature, and curing time for the poured concrete 12.

In some embodiments, a 185 cubic feet air compressor 38 or other suitable air compressor may be utilized to provide the 35 PSI to 75 PSI of compressed air during the hydro mulch application process. In some embodiments, the introduction of compressed air into the spray nozzle 26 during the spraying of hydro mulch material 22 enables a construction worker to paint hydro mulch material 22 over poured or applied concrete 12. In some embodiments, the hydro mulch material may additionally include some binder compounds such as supplemental fibers or adhesives, dependent upon specific application and condition requirements.

In some embodiments, the use of hydro mulch material 22 as sprayed onto a vertical or an overhang poured or applied concrete 12 surfaces facilitates moisture retention to a level of approximately 53-90% or more. In some embodiments, a period of time of approximately 96 to 120 hours may be required for slow curing of concrete 12, upon non-horizontal and/or horizontal surfaces.

In some embodiments it is undesirable to include materials formed of oak, which include acid, within the hydro mulch material 22. The oak material may discolor previously poured or applied concrete 12. In addition, sawdust does not provide the required temperature regulation, moisture content, and curing time control which are required to accurately regulate the curing of poured or applied concrete 12.

The introduction of air into the spray nozzle 26 facilitates the distribution and control of the application of hydro mulch material 22 dependent upon the encountered ambient site conditions. The introduction of air facilitates the control of the thickness, coverage area, as well as other application parameters, in order to facilitate moisture retention adjacent to curing concrete 12.

In some embodiments, the valve 30 used for regulation of the volume of air passing in spray nozzle 26 may be adjacent to the exit port 34. Air pressure may be adjusted proximate to the exit port 34 to provide a variety of alternative levels of spraying parameters. In some embodiments, the hydro mulch material 22 applied to a surface as disclosed herein will exit the spray nozzle 26 at a rate of between 10 and 200 cubic feet per minute. In other embodiments the hydro mulch material 22 applied to a surface as disclosed herein will exit the spray nozzle 26 at a rate of between 10 and 150 cubic feet per minute or alternatively between approximately 10 and 100 cubic feet per minute.

In some embodiments a material valve 36 may also be incorporated into the spray nozzle 26 or into the material hose 24 adjacent to the spray nozzle 26.

In some embodiments the method employs the use of compressed air in communication with the disclosed nozzle, or other appropriate spray nozzle 26, in order to spray seedless hydro mulch materials 22 and hydro seeding materials onto concrete 12, soils, dirt piles, road side jobs, commercial, residential applications and the like. The use of compressed air and the disclosed nozzle, or other appropriate spray nozzle 26, provides an enhanced control of the application pattern and a more uniform application of hydro mulch material 22 onto a desired surface. The enhanced application process reduces rebound or splatter and provides a cleaner application upon a surface. The seeded or seedless hydro mulch material 22 may also be rewetted after a period of time as needed to ensure moisture or dust control for a designated surface.

In at least one embodiment, the nozzle 26 includes a T fitting where air passage 28 joins the material hose 24 proximate to the exit port 34.

The disclosed product and method may be used in any type of seedless or seeded soil or surface construction, rehabilitation and/or repair project. The disclosed invention allows construction employees to more closely regulate temperature and moisture while simultaneously improving the efficiency, uniformity and quality of the application process, saving time, reducing waste, and saving cost.

In some embodiments the air compressor controller 50 may be used to increase or reduce pressurized air introduced into conduit 28 to change the velocity of hydro mulch material 22 exiting the nozzle 26, and the application of the hydro mulch material 22 onto a surface.

In some embodiments, pressurized air is introduced into the seeded or seedless hydro mulch material 22 for spraying onto a desired surface in order to regulate the application thickness, moisture content, and/or temperature of the covered surface. In some embodiments, 35 PSI air is introduced during the deposit of a seeded or seedless hydro mulch material 22 formed of 50 pounds of seeded or seedless hydro mulch mixed with 100 gallons of water and agitated for a period of time between five and seven minutes. In some embodiments, an 185 cubic feet air compressor 38, or other suitable air compressor, may be utilized to provide the 35 PSI to 75 PSI of air during the application process. In some embodiments, the range of PSI may be between approximately 35 PSI and 75 PSI.

In some embodiments the diameter size for the orifice 34 may be increased or decreased as needed to facilitate the spraying of the hydro mulch material 22 onto a desired surface. In some embodiments, pressurized air is introduced into the hydro mulch stream proximate to the orifice 34. In some embodiments, the introduction of air into the nozzle 26 during the spraying of hydro mulch material 22 enables a construction worker to paint hydro mulch material 22 onto a desired surface.

In some embodiments, a regulator or valve 30 for air pressure may be adjacent to the exit port 34 where the air pressure may be adjusted at the nozzle 26 to provide a desired level of spraying parameters.

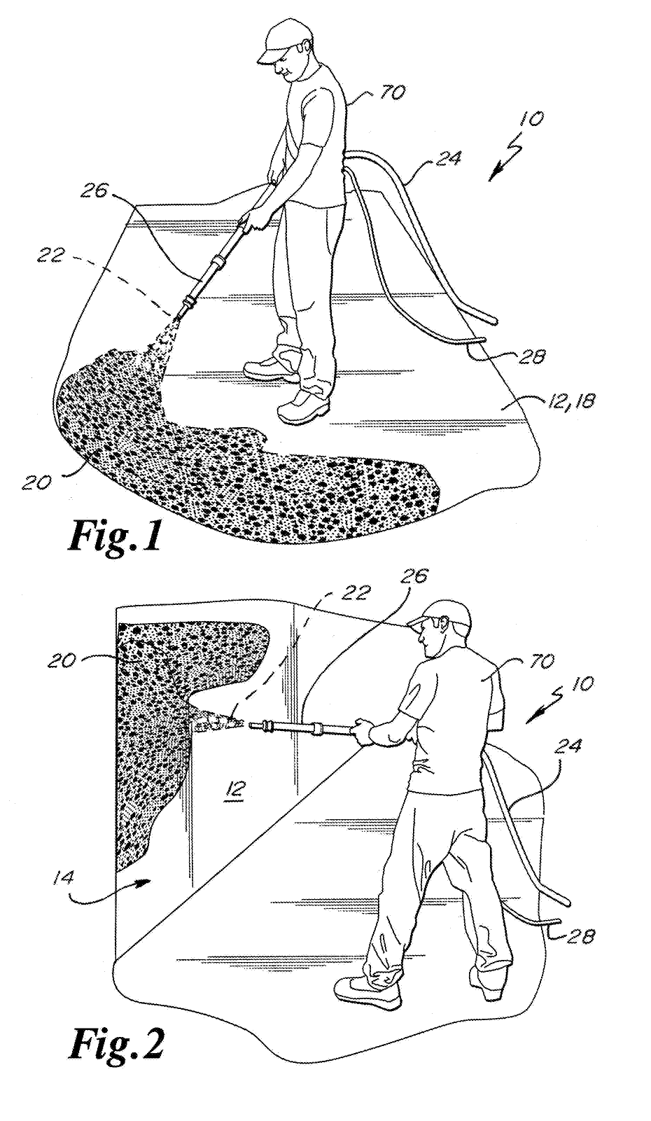

In some embodiments as depicted in FIG. 1, an individual is shown applying sprayed hydro mulch material 33 from the spray nozzle 26 onto a horizontal concrete 12 surface which is curing. The horizontal concrete 12 surface in one embodiment may be a bridge deck.

In some embodiments as depicted in FIG. 2, an individual is shown applying sprayed hydro mulch material 33 from the spray nozzle 26 onto a vertical concrete 12 surface which is curing. The vertical concrete 12 surface in one embodiment may be a concrete wall supporting a bridge.

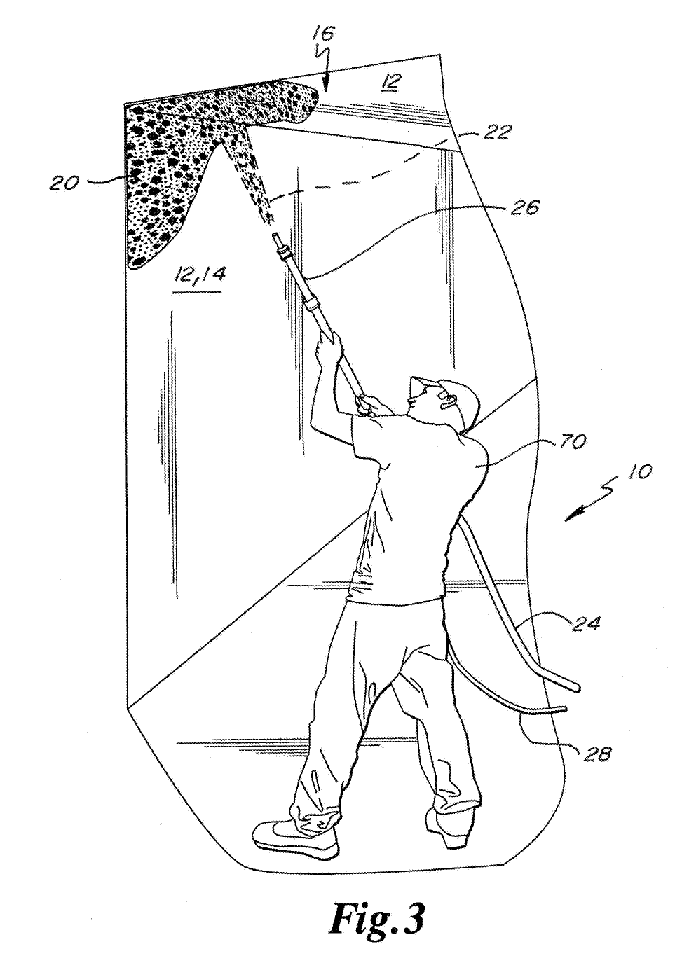

In some embodiments as depicted in FIG. 3, an individual is shown applying sprayed hydro mulch material 33 from the spray nozzle 26 onto a horizontal overhead concrete 12 surface which is curing. The horizontal overhead concrete 12 surface in one embodiment is the underside of a deck.

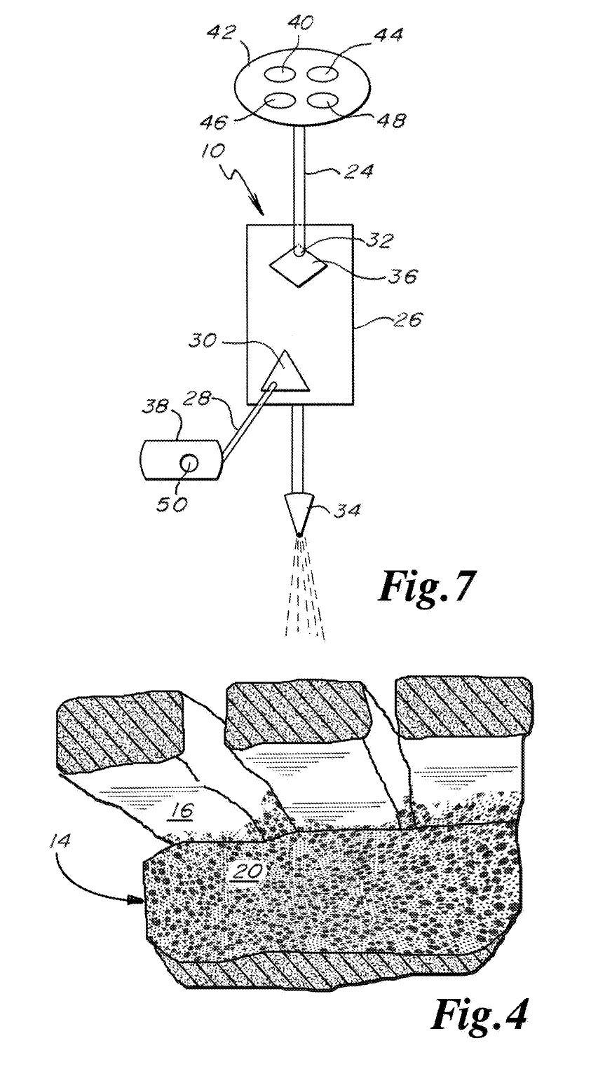

In at least one embodiment as depicted in FIG. 4, the hydro mulch material 22 is shown as deposited on a vertical wall surface during the curing of the previously poured or applied concrete 12.

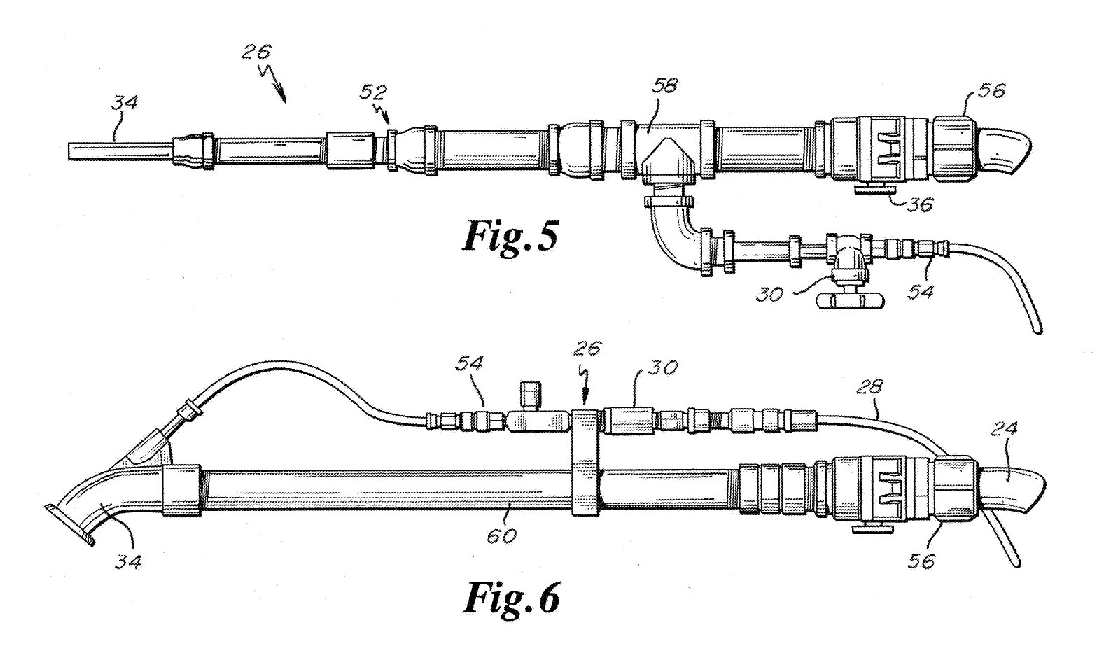

In at least one embodiment as depicted in FIG. 5, a spray nozzle 26 is shown. Spray nozzle 26 includes an exit port 34, a tapered section 52 of gradually decreasing diameter, an air valve 30 in communication with the tapered section 52, a first coupler 54 which is adapted for releasable connection to an air hose or line 28. The spray nozzle 26 also includes a material valve 36 and second coupler 56 which is adapted for releasable connection to a material hose 24. In some embodiments the hydro mulch material 22 and pressurized air are mixed at a t-fitting 58 in the tapered section 52. In this embodiment, hydro mulch material 22 is mixed with air a desired distance away from the exit port 34 along the tapered section 52. In this embodiment, the air valve 30 is located proximate to the material valve 36 in order to facilitate convenience of manipulation of either valve by an individual.

In at least one embodiment as depicted in FIG. 6, a spray nozzle 26 is shown. Spray nozzle 26 includes an exit port 34, a longitudinal section 60 of substantially constant diameter, an air valve 30 separated from and proximate to the longitudinal section 60, a first coupler 54, which may be a quick release pneumatic coupler, providing for releasable connection to an air hose or line 28. The spray nozzle 26 also includes a material valve 36 (not shown) and second coupler 56 which is adapted for releasable connection of a material hose 24 to the longitudinal section 60. In some embodiments the hydro mulch material 22 and pressurized air are mixed proximate to the exit port 34. In this embodiment, the air valve 30 is located at a desired position relative to the longitudinal section 60 in order to facilitate convenience of the grasping and use of the nozzle 26 during the application of hydro mulch material 22 onto a curing concrete surface 12.

In a first embodiment a method of curing concrete is disclosed the method initiating with the acquisition of seedless hydro mulch material and incorporating the seedless hydro mulch material into a material spraying device, mixing the seedless hydro mulch material with water in the material spraying device and spraying the mixed seedless hydro mulch material and water onto the surface of curing concrete.

In a second embodiment according to the first embodiment, the method further includes using a spray nozzle during the spraying of the mixed seedless hydro mulch material and water.

In a third embodiment according to the second embodiment, the pressurized air is introduced into the spray nozzle prior to the spraying of the mixed seedless hydro mulch material and water.

In a fourth embodiment according to the third embodiment, the pressurized air is provided to said spray nozzle at an air pressure of equal to or greater than 35 psi and less than or equal to 75 psi.

In a fifth embodiment according to the fourth embodiment, the spraying of the mixed seedless hydro mulch material and water covers the curing concrete in a wet blanket of the mixed seedless hydro mulch material and water.

In a sixth embodiment according to the fifth embodiment, the mixed seedless hydro mulch material and water is sprayed onto at least one of a horizontal surface, a vertical surface and a horizontal overhead surface.

In a seventh embodiment according to the fifth embodiment, the wet blanket is at least one of flexible, breathable and subject to re-moisturization.

In an eightieth embodiment according to the fifth embodiment, the wet blanket has a thickness dimension of greater than or equal to approximately ⅛ inch and less than or equal to approximately 5/16 inch.

In a ninth embodiment according to the eightieth embodiment, the wet blanket has a thickness dimension of approximately 3/16 inch.

In a tenth embodiment according to the fourth embodiment, the mixed seedless hydro mulch material and water is disposed on the curing concrete for a period of time of approximately seven days.

In an eleventh embodiment according to the tenth embodiment, the mixed seedless hydro mulch material and water following placement on the curing concrete, and following partial drying of the mixed seedless hydro mulch material and water, receives exposure to moisture for re-wetting.

In a twelfth embodiment according to the eleventh embodiment, the re-wetting of the mixed seedless hydro mulch material and water with moisture regulates a temperature for the curing concrete.

In a thirteenth embodiment according to the twelfth embodiment, the moisture used for re-wetting of the mixed seedless hydro mulch material and water is not equal to, or greater than 20 degrees higher than the temperature of the curing concrete or is not equal to, or less than 20 degrees lower than the temperature of the curing concrete.

In a fourteenth embodiment according to the thirteenth embodiment, approximately 50 pounds of seedless hydro mulch material is mixed with a volume of water equal to or greater than 75 gallons and less than or equal to 125 gallons.

In a fifteenth embodiment according to the fourteenth embodiment, the seedless hydro mulch material and the water will be mixed for a period of time of greater than or equal to 5 minutes or less than or equal to 7 minutes.

In a sixteenth embodiment according to the fifteenth embodiment, a 185 cubic feet air compressor is used to generate the pressurized air.

In a seventeenth embodiment according to the sixteenth embodiment, the mixed seedless hydro mulch material and water further comprises binder compounds.

In an eighteenth embodiment according to the seventeenth embodiment, the mixed seedless hydro mulch material and water exits the spray nozzle at a rate of greater than or equal to 10 cubic feet per minute and less than or equal to 200 cubic feet per minute.

In an nineteenth embodiment according to the seventeenth embodiment, the mixed seedless hydro mulch material and water exits the spray nozzle at a rate of greater than or equal to 10 cubic feet per minute and less than or equal to 150 cubic feet per minute.

In an twentieth embodiment according to the seventeenth embodiment, the mixed seedless hydro mulch material and water exits the spray nozzle at a rate of greater than or equal to 10 cubic feet per minute and less than or equal to 100 cubic feet per minute.

In an twenty-first embodiment according to the fourth embodiment, the material spraying device includes a tank, a mixer, a pump, and a pump controller.

In an twenty-second embodiment according to the twenty-first embodiment, the spray nozzle includes a material valve and an exit port.

In an twenty-third embodiment according to the twenty-second embodiment, the material spraying device includes an air compressor comprising an air conduit and an air compressor controller, the air conduit being in communication with the air valve and the exit port.

In an twenty-fourth embodiment according to the twenty-third embodiment, the material spraying device includes a material conduit, the material conduit being releasably connected to the spray nozzle.

In an twenty-fifth embodiment according to the twenty-fourth embodiment, the spray nozzle comprises a longitudinal section.

In an twenty-sixth embodiment according to the twenty-fifth embodiment, the longitudinal section comprises a tapered section.

In an twenty-seventh embodiment according to the twenty-sixth embodiment, the exit port has an exit orifice having a diameter dimension of greater than or equal to approximately ½ inch and less than or equal to approximately ¾ inch.

While this invention may be embodied in many different forms, there are shown in the drawings and described in detail herein specific embodiments of the invention. The present disclosure is an exemplification of the principles of the invention and is not intended to limit the invention to the particular embodiments illustrated.

The present invention may be embodied in other specific forms without departing from the spirit or essential attributes thereof; and it is, therefore, desired that the present description be considered in all respects as illustrative and not restrictive, reference being made to the appended claims rather than to the foregoing description to indicate the scope of the invention.

In addition to being directed to the embodiments described above and claimed below, the present invention is further directed to embodiments having different combinations of the features described above and claimed below. As such, the invention is also directed to other embodiments having any other possible combination of the dependent features claimed below.

Those skilled in the art may also recognize other equivalents to the specific embodiments described herein which equivalents are intended to be encompassed by the claims attached hereto.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

This completes the description of the embodiments of the invention. Those skilled in the art may recognize other equivalents to the specific embodiment described herein which equivalents are intended to be encompassed by the claims attached hereto.

I claim:

1. A method of curing concrete comprising:
a. obtaining seedless hydro mulch material and incorporating the seedless hydro mulch material into a material spraying device;
b. mixing the seedless hydro mulch material with water in the material spraying device; and
c. spraying the mixed seedless hydro mulch material and water onto the surface of curing concrete.

2. The method of claim 1, further comprising using a spray nozzle during the spraying of the mixed seedless hydro mulch material and water.

3. The method of claim 2, further comprising introducing pressurized air into the spray nozzle prior to the spraying of the mixed seedless hydro mulch material and water.

4. The method of claim 3, wherein said pressurized air is provided to said spray nozzle at an air pressure of equal to or greater than 35 psi and less than or equal to 75 psi.

5. The method of claim 4, wherein said spraying of said mixed seedless hydro mulch material and water covers said curing concrete in a wet blanket of said mixed seedless hydro mulch material and water.

6. The method of claim 4, wherein said mixed seedless hydro mulch material and water is sprayed onto at least one of a horizontal surface, a vertical surface and a horizontal overhead surface.

7. The method of claim 5, wherein said wet blanket is at least one of breathable and subject to re-moisturization.

8. The method of claim 5, wherein said wet blanket has a thickness dimension of greater than or equal to approximately ⅛ inch and less than or equal to approximately 5/16 inch.

9. The method of claim 8, wherein said wet blanket has a thickness dimension of approximately 3/16 inch.

10. The method of claim 4, wherein said mixed seedless hydro mulch material and water is disposed on said curing concrete for a period of time of approximately seven days.

11. The method of claim 10, wherein said mixed seedless hydro mulch material and water following placement on said curing concrete, and following partial drying of said mixed seedless hydro mulch material and water, receives exposure to moisture for re-wetting.

12. The method of claim 11, wherein said re-wetting of said mixed seedless hydro mulch material and water with moisture regulates a temperature for said curing concrete.

13. The method of claim 12, wherein said moisture used for re-wetting of said mixed seedless hydro mulch material and water is not equal to, or greater than 20 degrees higher than said temperature of said curing concrete or is not equal to, or less than 20 degrees lower than said temperature of said curing concrete.

14. The method of claim 13, wherein approximately 50 pounds of seedless hydro mulch material is mixed with a volume of water equal to or greater than 75 gallons and less than or equal to 125 gallons.

15. The method of claim 14, wherein said seedless hydro mulch material and said water will be mixed for a period of time of greater than or equal to 5 minutes or less than or equal to 7 minutes.

16. The method of claim 15, wherein a 185 cubic feet air compressor is used to generate said pressurized air.

17. The method of claim 16, said mixed seedless hydro mulch material and water further comprising binder compounds.

18. The method of claim 16, said mixed seedless hydro mulch material and water exits said spray nozzle at a rate of greater than or equal to 10 cubic feet per minute and less than or equal to 200 cubic feet per minute.

19. The method of claim 16, said mixed seedless hydro mulch material and water exits said spray nozzle at a rate of greater than or equal to 10 cubic feet per minute and less than or equal to 150 cubic feet per minute.

20. The method of claim 16, said mixed seedless hydro mulch material and water exits said spray nozzle at a rate of greater than or equal to 10 cubic feet per minute and less than or equal to 100 cubic feet per minute.

21. The method of claim 2, said material spraying device comprising a tank, a mixer, a pump, and a pump controller.

22. The method of claim 21, said spray nozzle comprising a material valve and an exit port.

23. The method of claim 22, said material spraying device further comprising a material conduit, said material conduit being releasably connected to said spray nozzle.

24. The method of claim 23, said spray nozzle comprising a longitudinal section.

25. The method of claim 24, said longitudinal section comprising a tapered section.

26. The method of claim 25, wherein said exit port has an exit orifice having a diameter dimension of greater than or equal to approximately ½ inch and less than or equal to approximately ¾ inch.
